(19) United States
(12) Patent Application Publication
(10) Pub. No.: US 2006/0139117 A1
(43) Pub. Date: Jun. 29, 2006

(54) Multi-channel waveguide structure

(76) Inventors: David L. Brunker, Naperville, IL (US); Philip J. Dambach, Naperville, IL (US); Kent E. Regnier, Lombard, IL (US); Martin U. Ogbuokiri, Aurora, IL (US)

Correspondence Address: MOLEX INCORPORATED, 2222 WELLINGTON COURT, LISLE, IL, 60532, US

(21) Appl. No.: 11/023,907

(22) Filed: Dec. 23, 2004

(51) Int. Cl. H01P 3/08

(52) U.S. Cl. 333/1; 333/5

(57) ABSTRACT

Slot transmission lines are formed in dielectric substrates. Several of such substrates can be stacked together. When stacked together, the conductive surfaces that form the transmission lines can be terminated in the same plane whereat the conductive surfaces form contact terminals. The co-planar contact terminals can be coupled to contact points on a circuit board. Signals on the circuit board can thereby be coupled into the slot transmission lines that extend through the dielectric substrates.

### REFERENCE TO RELATED APPLICATIONS

This application claims priority from prior U.S. Provisional Patent Application No. 60/32,674, filed Dec. 24, 2004.

### BACKGROUND OF THE INVENTION

The present invention pertains to multi-circuit electronic communication systems, and more particularly, to a dedicated transmission channel structure for use in such systems and which can be utilized in all parts of a transmission system, chip packaging, printed circuit board construction, interconnect device, launches to and from chips, circuit boards, interconnects and cables.

Various means of electronic transmission are known in the art. Most, if not all of these transmission means, suffer from inherent speed limitations such as both the upper frequency limit and the actual time a signal requires to move from one point to another within the system, which is commonly referred to as propagation delay. They simply are limited in their electronic performance primarily by their structure, and secondarily by their material composition. One traditional approach utilizes conductive pins, such as those found in an edge card connector as is illustrated in FIG. 1. In this type of structure a plurality of conductive pins, or terminals 20, are arranged within a plastic housing 21 and this arrangement provides operational speeds of about 800 to 900 MHz. An improvement upon this standard structure is represented by edge card connectors that may be known in the art as “Hi-Spec” and which are illustrated in FIG. 2, in which the system includes large ground contacts 25 and small signal contacts 26 disposed within an insulative connector housing 27. The smaller signal contacts 26 couple to the larger ground contacts 25. The signal contacts in these structures are not differential signal contacts, but are merely single-ended signal, meaning that every signal contact is flanked by a ground contact. The operational speeds for this type of system are believed to be about 2.3 Ghz.

Yet another improvement in this field is referred to as a “triad” or “triple” connector in which conductive terminals are disposed within a plastic housing 28 in a triangular pattern, and the terminals include a large ground terminal 29, and two smaller differential signal terminals 30, as illustrated in FIG. 3, and, as described in greater detail U.S. Pat. No. 6,280,209. This triad/triple structure has an apparent upper limit speed of about 4 Ghz. All three of these approaches utilize, in the simplest sense, conductive pins in a plastic housing in order to provide a transmission line for electronic signals.

In each of these type constructions, it is desired to maintain a functional transmission structure through the entire delivery path of the system, including through the circuit board(s), the mating interface and the source and load of the system. It is difficult to achieve the desired uniformity within the system when the transmission system is constructed from individual pins. Discrete point-to-point connections are used in these connectors for signal, ground and power. Each of these conductors was designed as either a conductor or a means of providing electrical continuity and usually did not take into account transmission line effects. Most of the conductors were designed as a standard pinfield so that all the pins, or terminals, were identical, regardless of their designated electrical function and the pins were further arranged at a standard pitch, material type and length. Although satisfactory in performance at low operating speeds, at high operational speeds, these systems would consider the conductors as discontinuities in the system that affect the operation and speed thereof.

Many signal terminals or pins in these systems were connected to the same ground return conductor, and thus created a high signal to ground ratio, which did not lend themselves to high-speed signal transmission because large current loops are forced between the signals and the ground, which current loops reduce the bandwidth and increase the cross talk of the system, thereby possibly degrading the system performance.

Bandwidth (“BW”) is proportional to 1/\sqrt{(LC)}, where L is the inductance of the system components, C is the capacitance of the system components and BW is the bandwidth. The inductive and capacitive components of the signal delivery system work to reduce the bandwidth of the system, even in totally homogeneous systems without discontinuities. These inductive and capacitive components can be minimized by reducing the overall path length through the system, primarily through limiting the area of the current path through the system and reducing the total plate area of the system elements. However, as the transmission frequency increases, the reduction in size creates its own problem in that the effective physical length is reduced to rather small sizes. High frequencies in the 10 Ghz range and above render most of the calculated system path lengths unacceptable.

In addition to aggregate inductance and capacitance across the system being limiting performance factors, any non-homogeneous geometrical and/or material transitions create discontinuities. Using about 3.5 Ghz as a minimum cutoff frequency in a low voltage differential signal system operating at around 12.5 Gigabits per second (Gbps), the use of a dielectric with a dielectric constant of about 3.8 will yield a critical path length of about 0.25 inches, over which length discontinuities may be tolerated. This dimension renders impracticable the ability of one to construct a system that includes a source, transmission load and load within the given quarter-inch. It can thus be seen that the evolution of electronic transmission structures have progressed from uniform-structured pin arrangements to functionally dedicated pins arrangements to attempted unitary structured interfaces, yet the path length and other factors still limit these structures. With the aforementioned prior art structures, it was not feasible to carry high frequency signals due to the physical restraints of these systems and the short critical path lengths needed for such transmission.

In order to obtain an effective transmission system, one must maintain a constant and dedicated transmission line over the entire delivery path: from the source, through the interface and to the load. This would include the matable interconnects and printed circuit boards, the interconnect signal launch into and out from printed circuit boards or other transmission media such as cables, and even the semiconductor device chip packaging. This is very difficult to achieve when the delivery system is constructed from individual, conductive pins designed to interconnect with other individual conductive pins because of potential required changes in the size, shape and position of the pins/terminals with respect to each other. For example, in a right angle connector, the relationship between the rows of pins/terminals change in both the length and the electrical coupling. High speed interconnect design principles that include all areas between the source and load of the system including chip packaging, printed circuit boards, board connectors and cable assemblies are being used in transmission systems with sources of up to 2.5 Gbps. One such principle is the principle of ground by design, which provides added performance over a standard pin field in that coupling is enhanced between the signal and ground paths and single-ended operation is complimented. Another principle being used in such systems includes impedance tuning to minimize discontinuities. Yet another design principle is pinout optimization where signal and return paths are assigned to specific pins in the pin field to maximize the performance. These type of systems all are limited with respect to attaining the critical path lengths mentioned above.

The present invention is directed to an improved transmission or delivery system that overcomes the aforementioned disadvantages and which operates at higher speeds.

### SUMMARY OF THE INVENTION

The present directed is therefore directed to an improved transmission structure that overcomes the aforementioned disadvantages and utilizes grouped electrically conductive elements to form a unitary mechanical structure that provides a complete electronic transmission channel that is similar in one sense to a fiber optic system. The focus of the invention is on providing a complete, copper-based electronic transmission channel rather than utilizing either individual conductive pins or separable interfaces with copper conductors as the transmission channel, the transmission channels of the invention yielding more predictable electrical performance and greater control of operational characteristics. Such improved systems of the present invention are believed to offer operating speeds for digital signal transmission of up to at least 12.5 GHz at extended path lengths which are much greater than 0.25 inch.

Accordingly, it is a general object of the present invention to provide an engineered waveguide that functions as a grouped element channel link, where the link includes an elongated dielectric body portion and at least two conductive elements disposed along the exterior surface thereof.

Another object of the present invention is to provide a high-speed channel link (or transmission line) having an elongated body portion of a given cross-section, the body portion being formed from a dielectric with a selected dielectric constant, and the link having, in its most basic structure, two conductive elements disposed on the exterior surface thereof, the elements being of similar size and shape and oriented thereon, in opposition to each other, so as to steer the electrical energy wave traveling through the link by establishing particular electrical and magnetic fields between the two conductive elements and maintaining these fields throughout the length of the channel link.

A further object of the present invention is to control the impedance of the channel link by selectively sizing the conductive elements and the gaps therebetween on the exterior surface of the elongated body to maintain balanced or unbalanced electrical & magnetic fields.

Yet another object of the present invention is to provide a improved electrical transmission channel that includes a flat substrate, and a plurality of grooves formed in the substrate, the grooves having opposing sidewalls and the grooves being spaced apart by intervening lands of the substrate, the sidewalls of the grooves having a conductive material deposited thereon, such as by plating or deposition, to form electronic transmission channels within the grooves.

A still further object of the present invention is to provide a pre-engineered wave guide in which at least a pair of conductive elements are utilized to provide differential signal transmission, i.e., signal in (“+”) and signal out (“−”), the pair of conductive elements being disposed on the exterior of the dielectric body so as to permit the establishment of capacitance per unit length, inductance per unit length, impedance, attenuation and propagation delay per unit length, and establishing these pre-determined performance parameters within the channels formed by the conductive elements.

A yet further object of the present invention is to provide an improved transmission line in the form of a solid link, of preferably uniform, circular cross-section, the link including at least a pair of conductive elements disposed thereon that serve to guide the electrical wave therethrough, the link including at least one thin filament of dielectric material having two conductive surfaces disposed thereon, the conductive surfaces extending lengthwise of the filament and separated by two circumferential arcuate extents, the conductive surfaces further being separated from each other to form a discrete, two-element transmission channel that reduces the current loop and in which the signal conductors are more tightly aligned.

Yet another object of the present invention is to provide a non-circular transmission line for high speed applications, which includes an elongated rectangular or square dielectric member having an exterior surface with at least four distinct sectors disposed thereon, the dielectric member including a pair of conductive elements aligned with each other and disposed on two of the sectors, while separated by an intervening sector.

The present invention accomplishes the above and other objects by a layering multiple, slot transmission line structures. In one principal aspect, a transmission line that is formed from conductive strips along the opposing edges of slots through a dielectric. Several such transmission lines can be formed in a single substrate. When such substrates are stacked together, the conductive strips of each transmission line can be terminated in a common plane, enabling the transmission line structure to be mounted to a planar substrate by which signals can be routed directly to the different transmission lines from contact points on the circuit board. These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a schematic plan view of the terminating face of a conventional connector;

FIG. 2 is a schematic plan view of an edge card used in a high speed connector;

FIG. 3 is a schematic elevational view of a high speed connector utilizing a triad or triple;

FIG. 4 is a perspective view of a grouped element channel link constructed in accordance with the principles of the present invention.

FIG. 5 is a schematic end view of the grouped element channel link of FIG. 4 illustrating the arcuate extents of the conductive elements and the spacing there between;

FIG. 6 is a perspective view of an alternate embodiment of a grouped element channel link constructed in accordance with the principles of the present invention.

FIG. 7 is a schematic view of a transmission link of the present invention used to connect a source with a load having intermediate loads on the transmission link;

FIG. 8 is a schematic view of a connector element utilizing both conventional contacts “A” and the transmission links “B” of the invention, with enlarged detail portions at “A” and “B” thereof, illustrating the occurrence of inductance in the respective systems;

FIG. 9 is a perspective view of an alternate construction of a link of the invention with a right angle bend formed therein;

FIG. 10 is a schematic view of a transmission line utilizing the links of the present invention;

FIG. 11 is a perspective view illustrating alternate media compositions of the links of the invention;

FIG. 12 is a perspective view of an array of different shapes of dielectric bodies illustrating alternate conductive surface arrangements;

FIG. 13 is a perspective view of an array of non-circular cross-section dielectric bodies that may be used to form links of the invention;

FIG. 14 is a perspective view of another array of non-circular cross-section dielectric bodies suitable for use as links of the invention;

FIG. 15 is an exploded view of a connector assembly incorporating a multiple element link of the invention that is used to provide a transmission line between two connectors;

FIG. 16 is a perspective view of a connector assembly having two connector housings interconnected by the transmission link of FIG. 15;

FIG. 17 is a diagrammatic view of a transmission channel of the present invention with two interconnecting blocks formed at opposite ends of the channel and illustrating the potential flexible nature of the invention;

FIG. 18 is a perspective view of an array of differently configured dielectric bodies that may be used as links of the with different lens characteristics;

FIG. 19 is a perspective view of a multiple transmission link extrusion with different signal channels formed thereon;

FIG. 20 is a perspective view of a multiple transmission link extrusion used in the invention;

FIG. 21 is a perspective view of a mating interface used with a discrete transmission link of the invention, in which mating interface takes the form of a hollow endcap;

FIG. 22 is a rear perspective view of the endcap of FIG. 21, illustrating the center opening thereof that receives an end portion of the transmission link therein;

FIG. 23 is a frontal perspective view of the endcap of FIG. 21, illustrating the orientation of the exterior contacts;

FIG. 24 is a plan view of a multiple transmission link right angle, curved connector assembly;

FIG. 25 is a perspective view of an alternate construction of one of the termination ends of the connector assembly;

FIG. 26 is a perspective view of a connector suitable for use in connecting transmission channel links of the present invention to a circuit board;

FIG. 27A is a skeletal perspective view of the connector of FIG. 26 illustrating, in phantom, some of the internal contacts of the connector;

FIG. 27B is a perspective view of the interior contact assembly of the connector of FIG. 27A, with the sidewalls removed and illustrating the structure and placement of the coupling staple thereon;

FIG. 28 is a cross-sectional view of the connector of FIG. 26, taken along ines 28-28 thereof;

FIG. 29 is a perspective view of a dielectric substrate with two slot transmission lines.

FIG. 30 is a perspective view of three dielectric substrates assembled into a structure wherein each of substrates has two slot transmission lines.

FIG. 31 is an end view of a multi-substrate transmission line structure.

FIG. 32 is a perspective view of terminal ends of conductive strips and ground layers of multi-dielectric structures such as those shown in FIGS. 30 and 31.

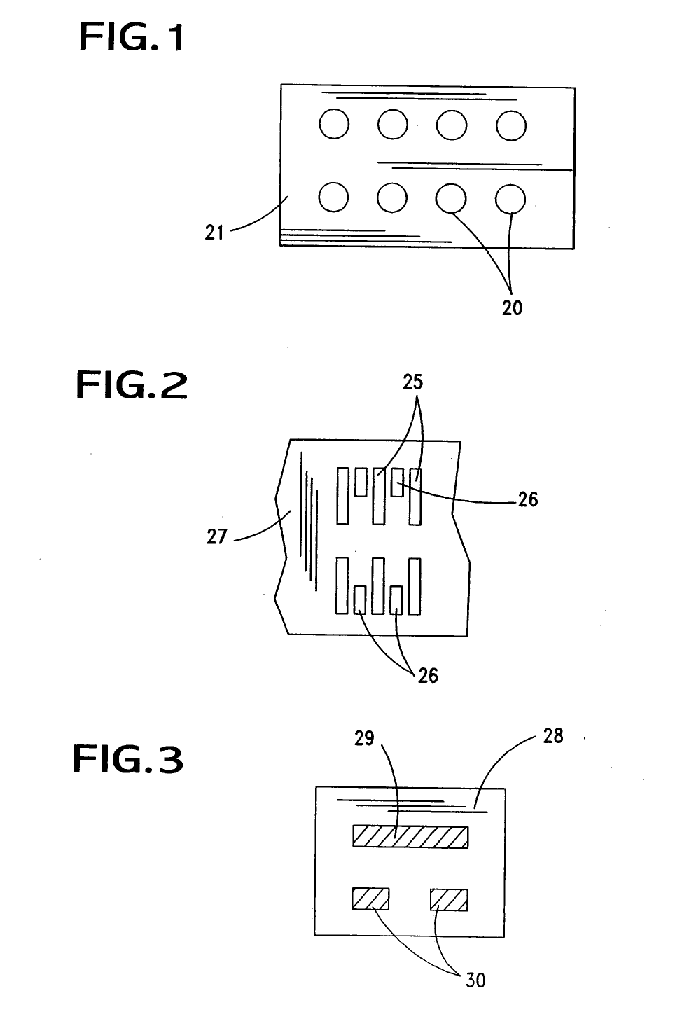

### DETAILED DESCRIPTION OF THE PREFERRED EMBOIDMENTS

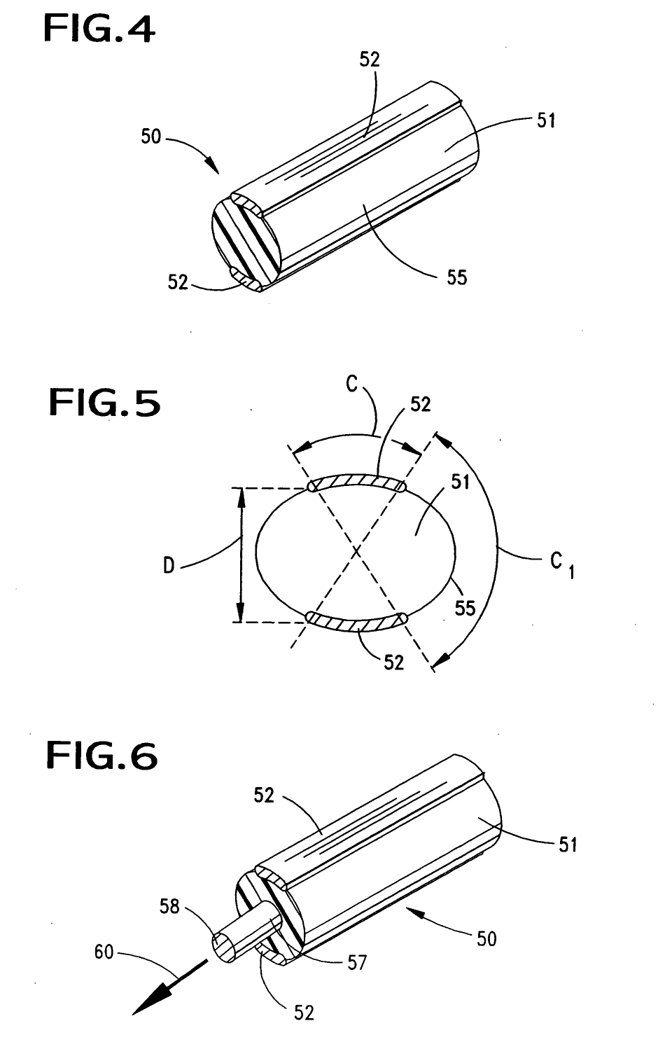

FIG. 4 illustrates a grouped element channel link 50 constructed in accordance with the principles of the present invention. It can be seen that the link 50 includes an elongated, dielectric body 51, preferably a cylindrical filament, that is similar to a length of fiber optic material. It differs therefrom in that the link 50 acts as a pre-engineered wave guide and a dedicated transmission media. In this regard, the body 51 is formed of a dedicated dielectric having a specific dielectric constant and a plurality of conductive elements 52 applied thereto. In FIGS. 4 and 5, the conductive elements 52 are illustrated as elongated extents, traces or strips, 52 of conductive material and, as such, they may be traditional copper or precious metal extents having a definite cross-section that may be molded or otherwise attached such as by adhesive or other means to the dielectric body of the link 50. They may also be formed on the exterior surface 55 of the body 51 such as by a suitable plating or vacuum deposition process. The conductive traces 52 are disposed on the exterior surface and have a width that extends along the perimeter of the dielectric body.

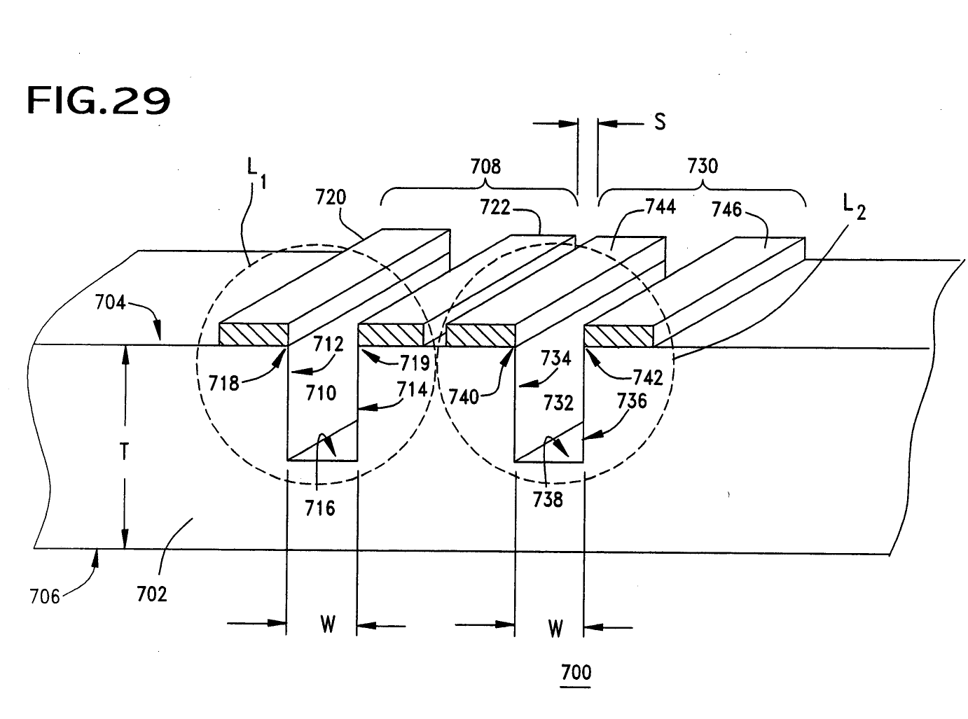

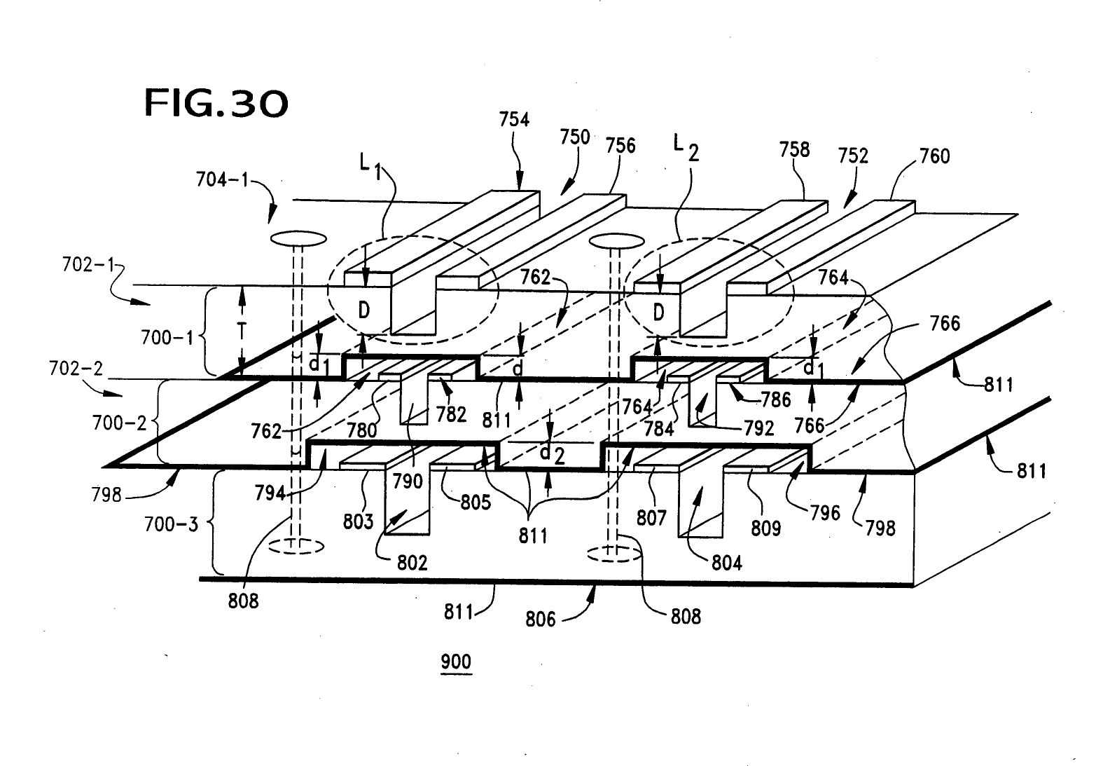

At least two such conductors are used on each link, typically are used for signal conveyance of differential signals, such as +0.5 volts and −0.5 volts. The use of such a differential signal arrangement permits us to characterize structures of this invention as pre-engineered waveguides that are maintained over substantially the entire length of the signal delivery path. The use of the dielectric body 51 provides for preferred coupling to occur within the link. In the simplest embodiment, as illustrated in FIG. 5, the conductive elements are disposed on two opposing faces, so that the electrical affinity of each of the conductive elements is for each other through the dielectric body upon which they are supported, or in the case of a conductive channel as will be explained in greater detail to follow and as illustrated in FIGS. 29-30, the conductive elements are disposed on two or more interior faces of the cavity/cavities to establish the primary coupling mode across the cavity gap and through an air dielectric. In this manner, the links of the present invention may be considered as the electrical equivalent to a fiber optic channel or extent.

The present invention is directed to electrical waveguides. The waveguides of the present invention are intended to maintain electrical signals at desired levels of electrical affinity at high frequencies from about 1.0 Ghz to at least 12.5 Ghz and preferably higher. Optical waveguides, as described in U.S. Pat. No. 6,377,741, issued Apr. 23, 2002, typically rely upon a single outer coating, or cladding, having mirror-like reflective properties to maintain the light energy moving in a selected direction. Openings in the outer coating/cladding will result in a dispersal of the light traveling through the waveguide, which adversely affects the light beam of the waveguide. Microwave waveguides are used at very high frequencies to direct the energy of the microwave beam, rather than transmit it as exemplified by U.S. Pat. No. 6,114,677, issued Sep. 5, 2002 in which a microwave waveguide is used to direct the microwaves at the center portion of an oven. Such a directional aim is also utilized the microwave antenna art. In each instance, these type of waveguides are used to focus and direct the energy of the light or microwaves traveling through them, whereas in the present invention, the entire waveguide structure is engineered to maintain the propagation of an electrical signal at a highre rate of propagation with a consistent impedance and reduced attenuation.

The effectiveness of the links of the present invention are dependent upon the guiding and maintenance of digital signals through the channel link, by utilizing two or more conductive surfaces of electrical containment. This will include maintaining the integrity of the signal, controlling the emissions and minimizing loss through the link. The channel links of the present invention contain the electromagnetic fields of the signals transmitted therethrough by controlling the material of the channel link and the geometries of the system components so that preferred field coupling will be provided. Simply stated, the present invention creates an engineered transmission line by defining a region of electrical affinity, i.e., the dielectric body 51, that is bounded by conductors, i.e., conductive surfaces 52, of opposing charge, i.e., negative and positive differential signals.

As illustrated better in FIG. 5, the two conductive surfaces 52 are arranged on the dielectric body 51 in opposition to each other. The dielectric body 51 shown in FIG. 4 takes the form of a cylindrical rod, while the dielectric body shown in FIG. 5 has an oval-like configuration. In each such instance, the conductive surfaces or traces 52, extend for distinct arc lengths. Both FIGS. 4 and 5 are representative of a “balanced” link of the invention where the circumferential extent, or arc length C of the two conductive surfaces 52 is the same, and the circumferential extents or arc lengths C1 of the non-conductive exterior surfaces 55 of the dielectric body 51 are also the same. This length may be considered to define a gross separation D between the conductive surfaces. As will be explained below, the link may be “unbalanced” with one of the conductive surfaces having an arc length that is greater than the other, and in such an instance, the transmission line is best suited for single-ended, or non-differential signal applications. In instances where the dielectric body and link are circular, the link may serve as a contact pin and so be utilized in connector applications. This circular cross-section demonstrates the same type of construction as a conventional round contact pin.

As illustrated in FIG. 6, the links of the present invention may be modified to provide not only multiple conductive elements as part of the overall system transmission media, but may also incorporate a coincident and coaxial fiber optic wave guide therewithin for the transmission of light and optical signals. In this regard, the dielectric body 51 is cored to create a central opening 57 through which an optical fiber 58 extends. Electrical signals may be transmitted through this link as well as light signals 60.

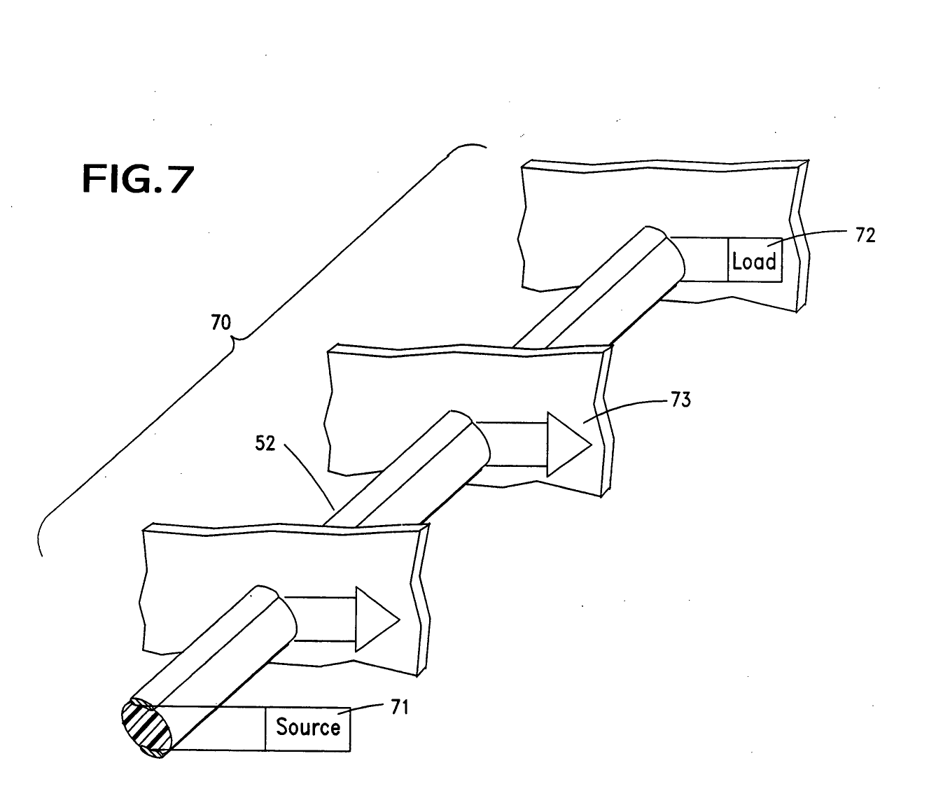

FIG. 7 schematically illustrates a transmission line 70 incorporating a link 50 of the present invention that extends between a source 71 and a load 72. The conductive surfaces 52 of the link serve to interconnect the source and load together, as well as other secondary loads 73 intermediate the source and the load. Such secondary loads may be added to the system to control the impedance through the system. A line impedance is established at the source and may be modified by adding secondary loads to the transmission line.

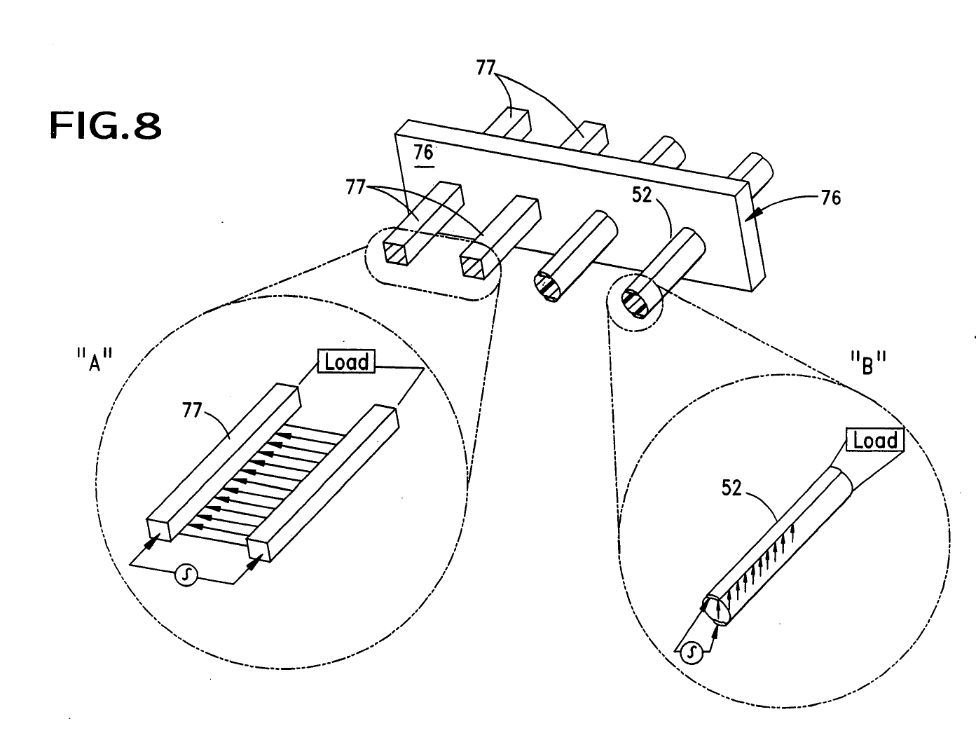

FIG. 8 illustrates, schematically, the difference between the links of the present invention and conventional conductors, which are both illustrated as supported by a dielectric block 76. Two discrete, conventional conductors 77 are formed from copper or another conductive material and extend through the block 76, in the manner of pins. As shown in enlargement “A”, the two discrete conductor presents an open cell structure with a large inductance (L) because of the enlarged current loop. Quite differently, the links of the present invention have a smaller inductance (L) at a constant impedance due to the proximity of the conductive surfaces to each other as positioned as the dielectric body 51. The dimensions of these links 50 can be controlled in the manufacturing process and extrusion will be the preferred process of manufacturing with the conductive surfaces being extended with the dielectric body or separately applied of the extrusion, such as by a selective plating process so that the resulting construction is of the plated plastic variety. The volume of the dielectric body 51 and the spacing between conductive elements disposed thereon may be easily controlled such an extrusion process. The conductive surfaces preferably extend for the length of the dielectric body and may end slightly before the ends thereof at a location where it is desired to terminate the transmission line to a connector, circuit board or similar component,

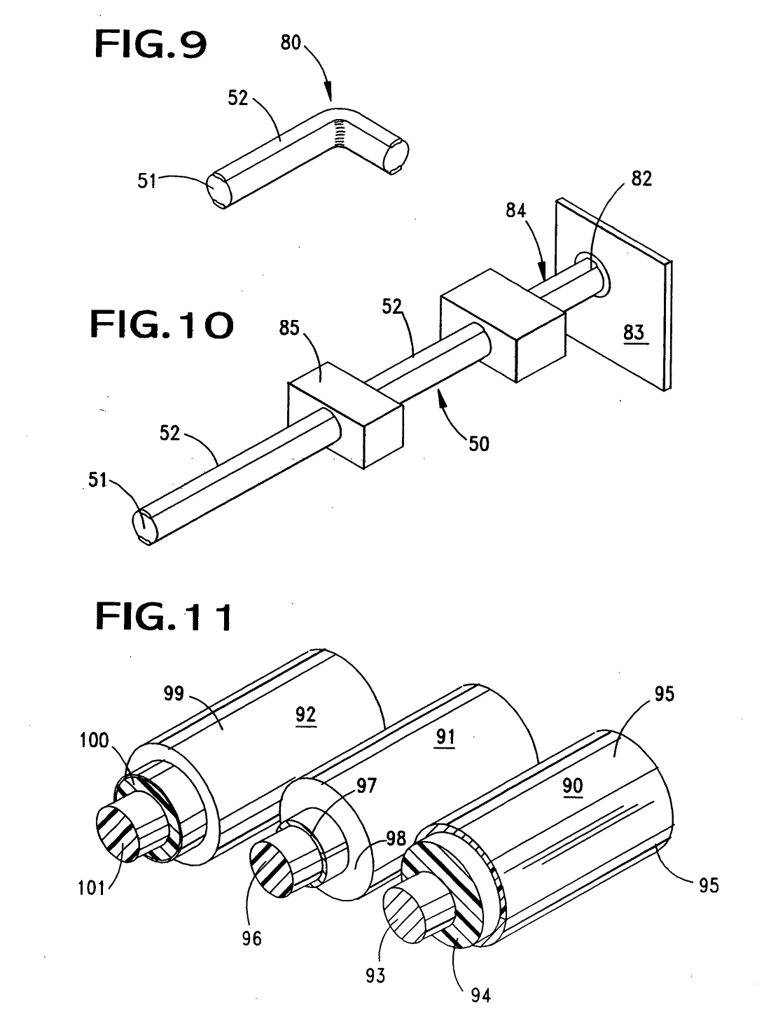

As FIG. 9 illustrates, the dielectric body may have a bend 80 forward therewith in the form of the 90.degree. right-angle bend illustrated or in any other angular orientation. As shown, the conductive surfaces 52 extend through the bend 80 with the same separation spacing between them and the same width with which the conductive surfaces start and end. The dielectric body 51 and the conductive surfaces 52 are easily maintained in their spacing and separation through the bend to eliminate any potential losses

FIG. 10 illustrates a transmission line using the links of the invention. The link 50 is considered as a transmission cable formed from one or more single dielectric bodies 51, and one end 82 of it is terminated to a printed circuit board 83. This termination may be direct in order to minimize any discontinuity at the circuit board. A short transfer link 84 that maintains any discontinuities at a minimum is also provided. These links 84 maintain the grouped aspect of the transmission link. Termination interfaces 85 may be provided where the link is terminated to the connector with minimum geometry discontinuity or impedance discontinuity. In this manner, the grouping of the conductive surfaces is maintained over the length of the transmission line resulting in both geometric and electrical uniformity.

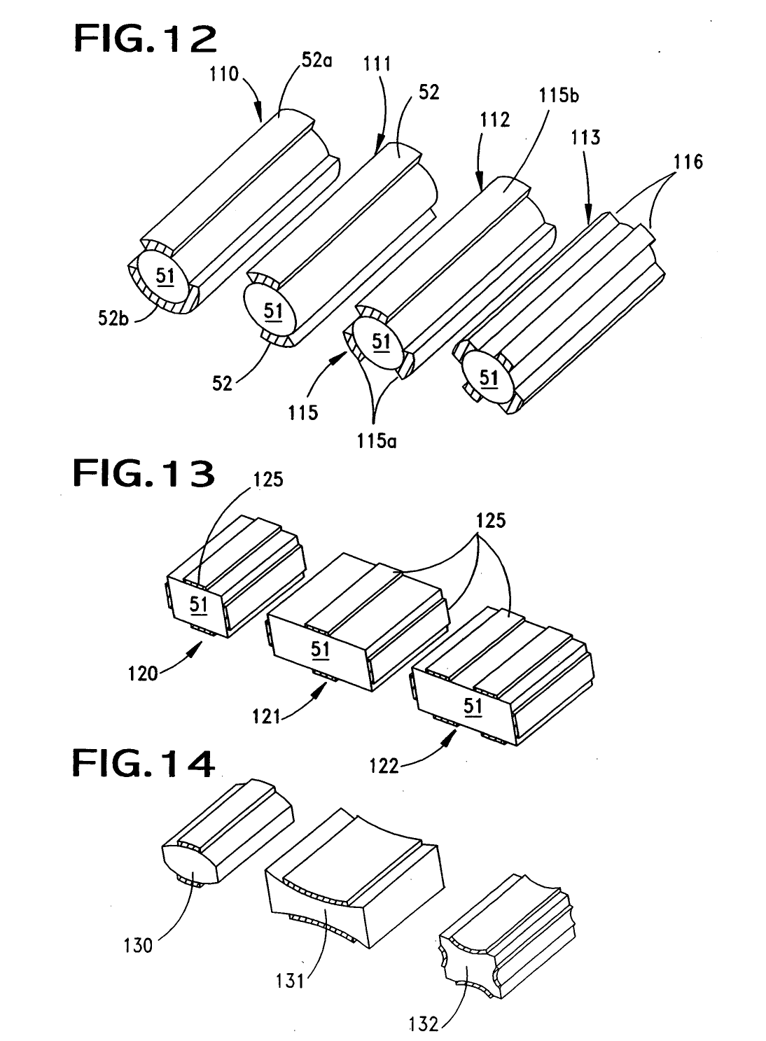

FIG. 11 illustrates a variety of different cross-sections of the transmission links 50 of the invention. In the rightmost link 90, a central conductor 93 is encircled by a hollow dielectric body 94 which in turn, supports multiple conductive surfaces 95 that are separated by an intervening space, preferably filled with portions of the dielectric body 94. This construction is suitable for use in power applications where power is carried by the central conductor 93. In the middle link 91 of FIG. 11, the central cover 96 is preferably made of a selected dielectric and has conductive surfaces 97 supported on it. A protective outer insulative jacket 98 is preferably provided to protect and or insulate the inner link. The leftmost link 92 of FIG. 11 has a protective outer jacket 99 that encloses a plateable polymeric ring 100 that encircles either a conductive or insulative core 101. Portions 101 of the ring 100 are plated with a conductive material and are separated by unplated portions to define the two or more conductive surfaces desired on the body of the ring. Alternatively, one or the elements surrounding the core or of the link 92 may be filled with air and may be spaced away from an inner member by way of suitable standoffs or the like.

FIG. 12 illustrates an array of links 110-113 that have their outer regions combined with the dielectric body 51 to form different types of transmission links. Link 110 has two conductive surfaces 52a, 52b of different arc lengths (i.e., unbalanced) disposed on the outer surface of the dielectric body 51 so that the link 110 may provide single-ended signal operation. Link 111 has two equal-spaced and sized (or “balanced”) conductive elements 52 to provide an effective differential signal operation.

Link 112 has three conductive surfaces 115 to support two differential signal conductors 115a and an assorted ground conductor 115b. Link 113 has four conductive surfaces 116 disposed on its dielectric body 51 in which the conductive surfaces 116 may either include two differential signal channels (or pairs) or a single differential pair with a pair of associated grounds.

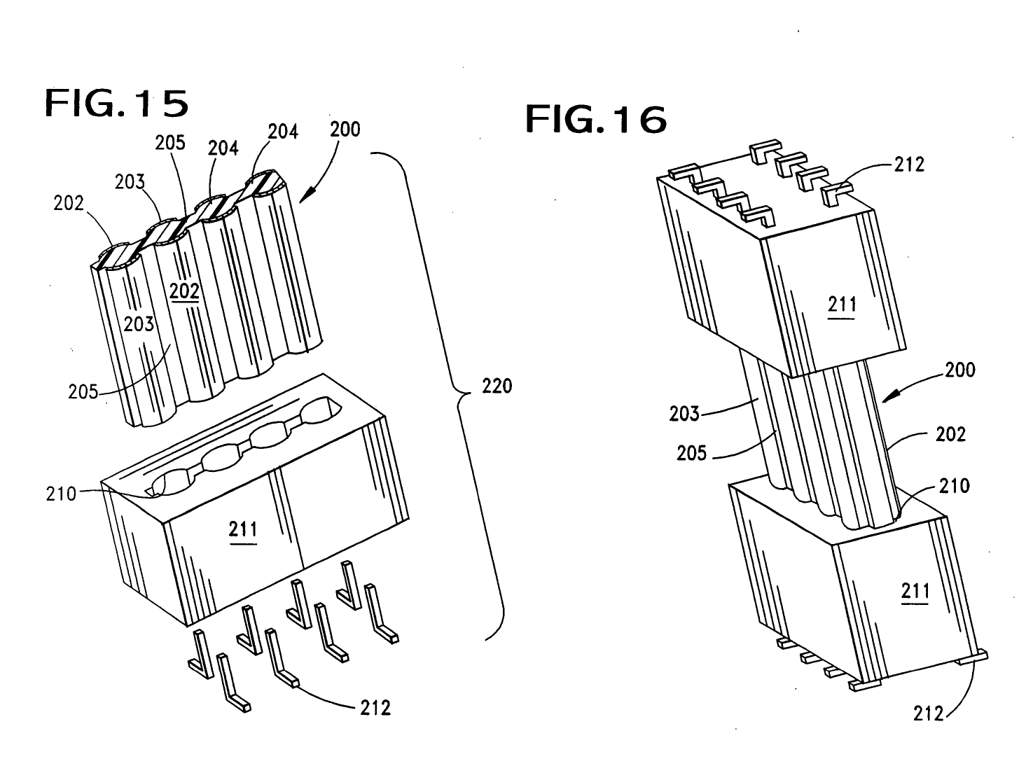

FIG. 13 illustrates an array of one-type of non-circular links 120-122 that polygonal configurations, such as square configurations, as with link 120 or rectangular configurations as with links 121-122. The dielectric bodies 51 may be extruded with projecting land portions 125 that are plated or otherwise covered with conductive material. Individual conductive surfaces are disposed on individual sides of the dielectric body and preferably differential signal pairs of the conductive surfaces are arranged on opposing sides of the body. These land portions 125 may be used to “key” into connector slots of terminating connectors in a manner so that contact between the connector terminals (not shown) and the conductive faces 125 is easily effected.

FIG. 14 illustrates some additional dielectric bodies that may be utilized with the present invention. One body 130 is shown as convex, while the other two bodies 131, 132 are shown as being generally concave in configuration. A circular cross-section of the dielectric bodies has a tendency to concentrate the electrical field strength at the corners of the conductive surfaces, while a slightly convex form as shown in body 130, has a tendency to concentrate the field strength evenly, resulting in lower attenuation. The concave bodies, as illustrated by dielectric bodies 131, 132 may have beneficial crosstalk reduction aspects because it focuses the electrical field inwardly. The width or arc lengths of these conductive surfaces, as shown in FIG. 14 are less that the width or arc lengths of the respective body sides supporting them.

Importantly, the transmission link may be formed as a single extrusion 200 (FIGS. 15-16) carrying multiple signal channels thereupon, with each such channel including a pair of conductive surface 202-203. These conductive surfaces 202, 203 are separated from each other by the intervening dielectric body 204 that supports them, as well as web portions 205 that interconnect them together. This extrusion 200 may be used as part of an overall connector assembly 220, where the extrusion is received into a complementary shaped opening 210 formed in a connector housing 211. The inner walls of the openings 210 may be selectively plated, or contacts 212 may be inserted into the housing 211 to contact the conductive surfaces and provide, if necessary, surface mount or through hole tail portions.

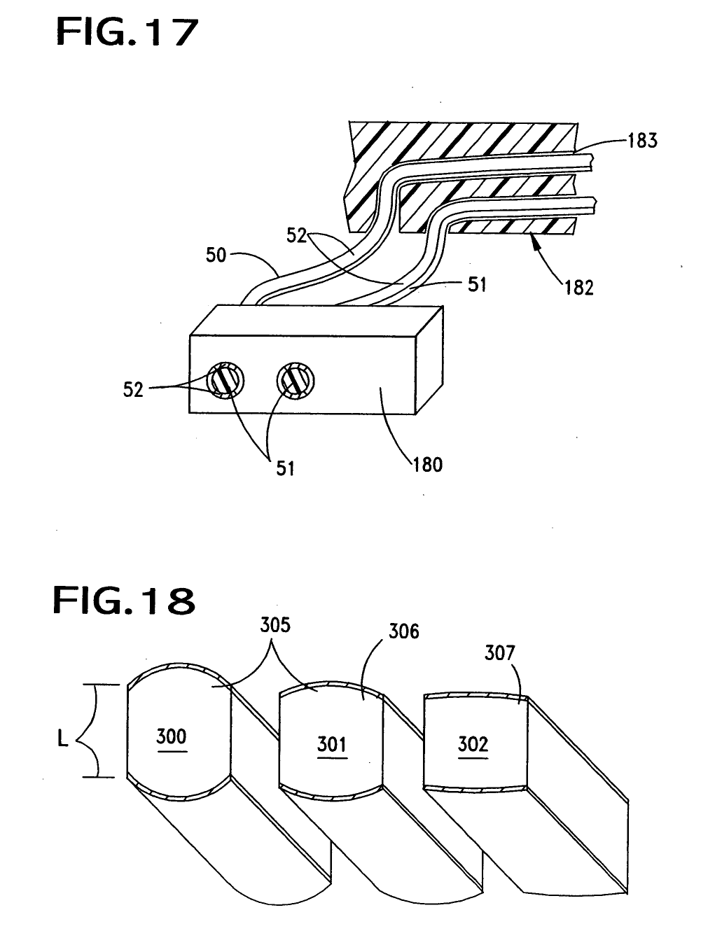

FIG. 17 illustrates the arrangement of two transmission channels 50 arranged as illustrated and terminated at one end to a connector block 180 and passing through a right angle block 182 that includes a series of right angle passages 183 formed therein which receive the transmission channel links as shown. In arrangements such as that shown in FIG. 17, it will be understood that the transmission channel links may be fabricated in a continuous manufacturing process, such as by extrusion, and each such channel may be manufactured with intrinsic or integrated conductive elements 52. In the manufacturing of these elements, the geometry of the transmission channel itself may be controlled, as well as the spacing and positioning of the conductive elements upon the dielectric bodies so that the transmission channels will perform as consistent and unitary electronic waveguides which will support a single channel or “lane” of signal (communication) traffic. Because the dielectric bodies of the transmission channel links may be made rather flexible, the systems of the invention are readily conformable to various pathways over extended lengths without significantly sacrificing the electrical performance of the system. The one connector endblock 180 may maintain the transmission channels in a vertical alignment, while the block 182 may maintain the ends of the transmission channel links in a right angle orientation for termination to other components.

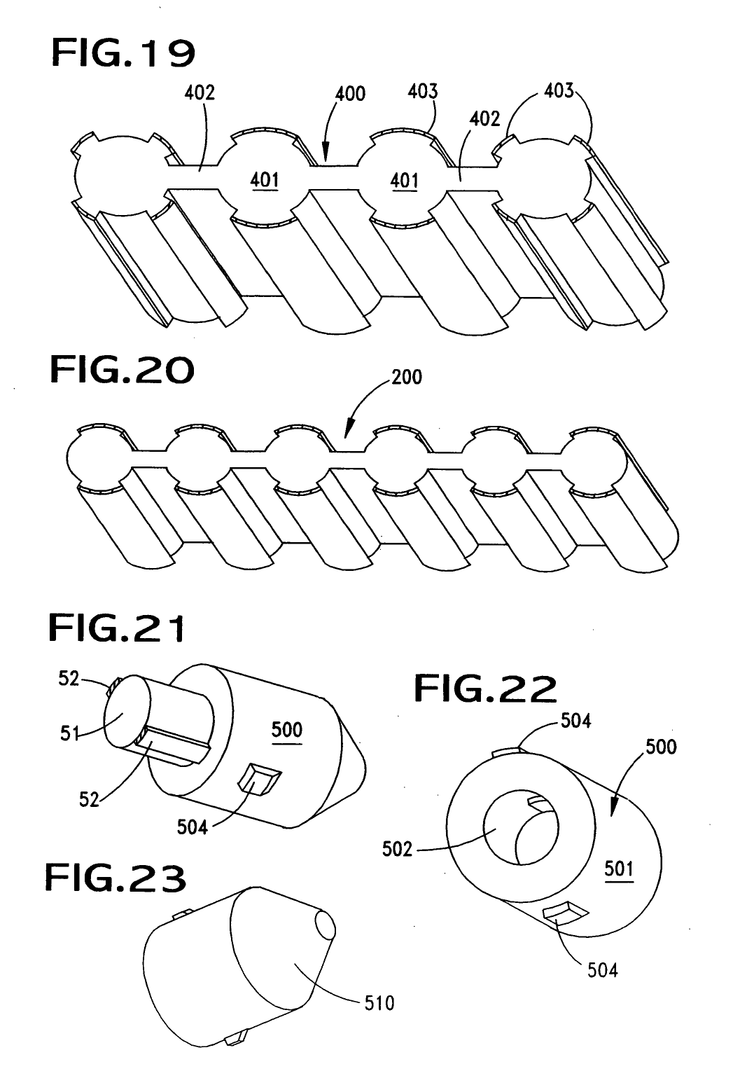

FIG. 18 illustrates a set of convex dielectric blocks or bodies 300-302 in which separation distance L varies and the curve 305 of the exterior surfaces 306 of the blocks rises among the links 300-302. In this manner, it should be understood that the shapes of the bodies may be chosen to provide different lens characteristics for focusing the electrical fields developed when the conductive elements are energized.

FIG. 19 illustrates a multiple channel extrusion 400 with a series of dielectric bodies or blocks 401 interconnected by webs 402 in which the conductive surfaces 403 are multiple or complex in nature. As with the construction shown in FIG. 13, such an extrusion 400 supports multiple signal channels, with each of the channels preferably including a pair of differential signal conductive elements.

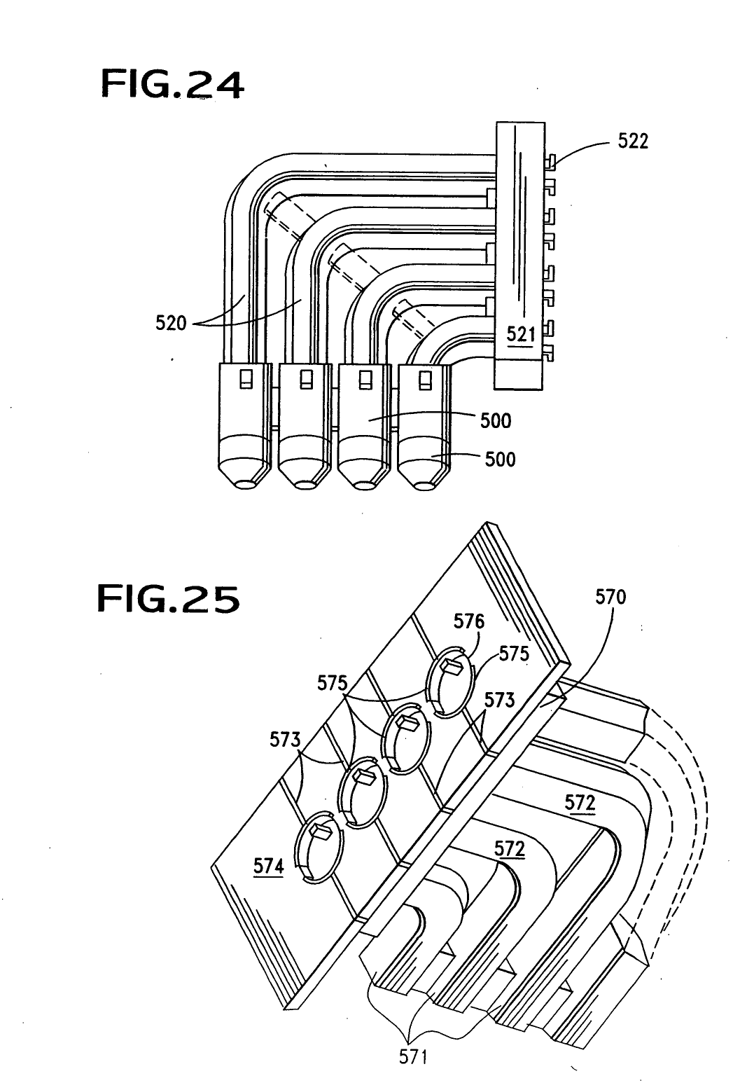

FIG. 20 illustrates a standard extrusion 200 such as that shown in FIGS. 15 and 16. The links of the present invention may be terminated into connector and other housings. FIGS. 21-23 illustrate one termination interface as a somewhat conical endcap which has a hollow body 501 with a central openings 502. The body may support a pair of terminals 504 that mate with the conductive surfaces 52 of the dielectric body 51. The endcap 500 may be inserted into various openings in connector housings or circuit boards and as such, preferably includes a conical insertion end 510. The endcap 500 may be structured to terminate only a single transmission line as is illustrated in FIGS. 21-23, or it may be part of a multiple termination interface and terminate multiple distinct transmission lines as illustrated in FIGS. 24 and 25.

FIG. 24 illustrates the endcaps 500 in place on a series of links 520 that are terminated to an endblock 521 that has surface mount terminals 522 so that the endblock 521 may be attached to a circuit board (not shown). The endcap need not take the conical structure shown in the drawings, but may take other shapes and configurations similar to that shown and described below.

FIG. 25 illustrates an alternate construction of an end block 570. In this arrangement, the transmission lines, or links 571, are formed from a dielectric and include a pair of conductive extents 572 formed on their exterior surfaces (with the extents 572 shown only on one side for clarity and their corresponding extents being formed on the surfaces of the links 571 that face into the plane of the paper of FIG. 25). These conductive extents 572 are connected to traces 573 on a circuit board 574 by way of conductive vias 575 formed on the interior of the circuit board 574. Such vias may also be constructed within the body of the end block 570, if desired. The vias 575 are preferably split as shown and their two conductive sections are separated by an intervening gap 576 to maintain separation of the two conductive transmission channels at the level of the board.

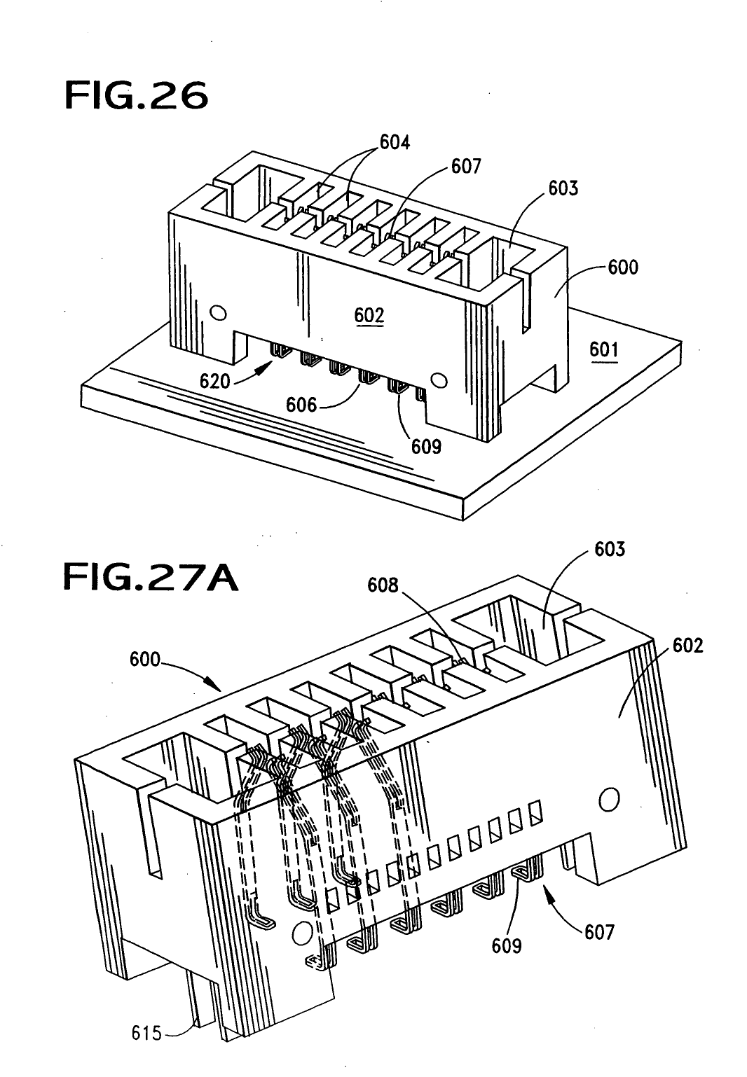

FIG. 26 illustrates an endcap, or block 600 mounted to a printed circuit board 601. This style of endcap 600 serves as a connector and thus includes a housing 602, with a central slot 603 with various keyways 604 that accept projecting portions of the transmission link. The endcap connector 600 may have a plurality of windows 620 for access to soldering the conductive tail portions 606 of the contacts 607 to corresponding opposing traces on the circuit board 601. In instances of surface mount tails a shown, the tails 606 may have their horizontal parts 609 tucked under the body of the endcap housing to reduce the circuit board pad size needed, as well as the capacitance of the system at the circuit board.

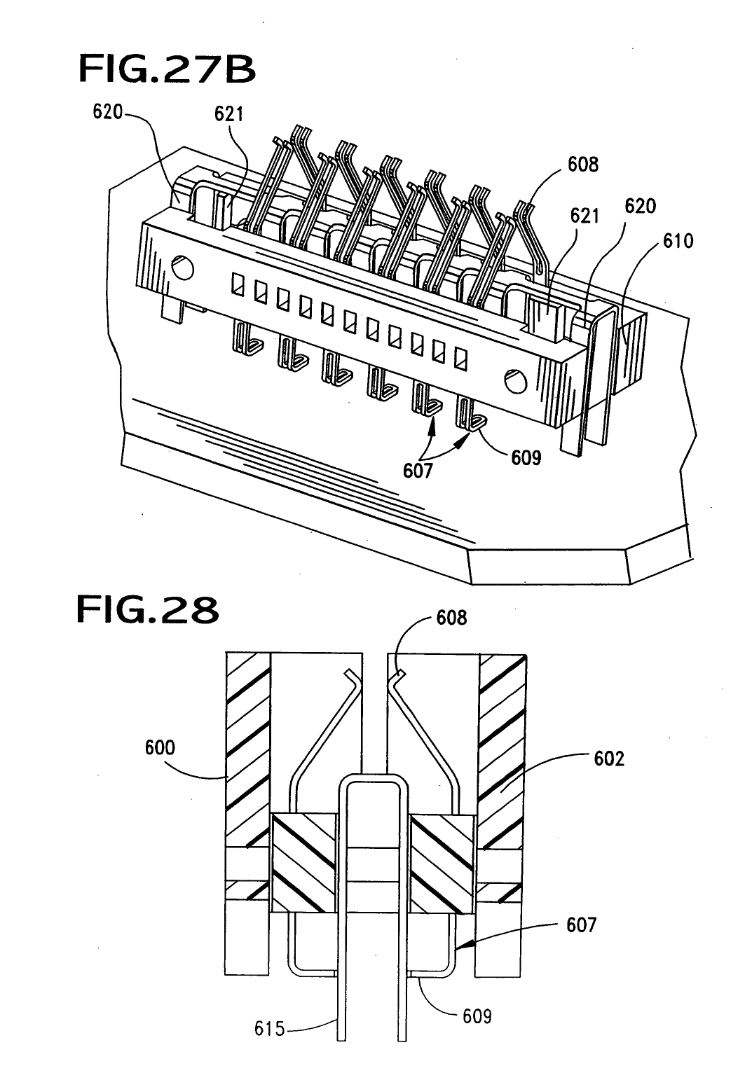

FIG. 27A illustrates a partial skeletal view of the endcap connector 600 and shows how the contacts, or terminals 607 are supported within and extend through the connector housing 602. The terminals 607 may include a dual wire contact end 608 for redundancy in contact (and for providing a parallel electrical path) and the connector 600 may include a coupling staple 615 that has an inverted U-shape and which enhances coupling of the terminals across the housing. The coupling staple 615 can be seen to have an elongated backbone that extends lengthwise through the connector housing 602. plurality of legs that are spaced apart from each other by spaces along the length of the coupling staple extend down toward the circuit board and each such leg has a width that is greater than a corresponding width of the terminal that it opposes. As shown in the drawings, the coupling staple legs are positioned in alignment with the terminals. The tail portions of these dual wire terminals 607 enhance the stability of the connector. In this regard, it also provides control for the terminals that constitute a channel (laterally) across the housing slot 601. he dual contact path not only provides for path redundancy but also reduces the inductance of the system through the terminals. FIG. 27B is a view of the interior contact assembly that is used in the endcap connector 600 of FIGS. 26 and 27A. The terminals 607 are arranged on opposite sides of the connector and are mounted within respective support blocks 610. These support blocks 610 are spaced apart from each other a preselected distance that assists in spacing the terminal contacts 608 apart.

A conductive coupling staple 615 having an overall U-shape, or blade shape, may be provided and may be interposed between the terminals 607 and support blocks 610 to enhance the coupling between and among the terminals 607. The coupling staple 615 has a series of blades 620 that are spaced apart by intervening spaces 621 and which are interposed between pairs of opposing contacts (FIG. 28) 6087 and which extend downwardly toward the surface of the circuit board. The staple 615 extends lengthwise through the connector body between the connector blocks 610. The connector blocks 610 and the connector housing 602 (particularly the sidewalls thereof) may have openings 616 formed therein that receive engagement plugs 617 therein to hold the two members in registration with each other. Other means of attachment may be utilized, as well.

FIG. 28 is an end view of the connector 600, which illustrates the interposition of the coupling staple between a pair of opposing contacts 608 and the engagement of the connector blocks 610 and the connector housing 602.

Notwithstanding the foregoing, FIG. 29 is an alternate embodiment of the invention, referred to hereinafter as a multi-channel transmission line substrate 700, so named because there are two separate transmission lines 708 and 730 formed within a single planar dielectric substrate 702. As shown in FIG. 29, a planar dielectric substrate 702 has both a planar “upper” surface 704 and a planar “lower” surface 706. Between the upper surface 704 and the lower surface 706 is dielectric material, the thickness of which is indicated in FIG. 29 as being “T.”

The designation of one surface as being an “upper” surface and the opposing surface as being a “lower” surface herein is only to simplify the description set forth herein. The planar dielectric substrate 702 can have any spatial orientation; either surface could be an “upper” or “lower” surface.

A first slot transmission line 708 (the conductors of which are also shown encircled as “L1”) is formed in the upper surface 704 of the planar dielectric substrate 702. The slot transmission line 708 is formed in part by a slot 710 through the substrate 702. The slot 710 through the substrate is characterized by two opposing surfaces or “faces” that are identified by reference numerals 712 and 714. These surfaces are separated from each other by an intervening distance or width W. Between the opposing surfaces or faces is the slot's bottom 716.

The intersection of the opposing face 712 with the upper surface 704 forms an “upper” edge 718 of the slot 710. The intersection of the other face 714 with the upper surface 704 forms a second “upper” edge 719.

After the slot 710 is formed, the first slot transmission line 708 is formed by two electrically-isolated conductive strips 720 and 722 along each of the upper edges 718 and 719. Alternate and equivalent embodiments contemplate the first slot transmission line formed by a single conductive strip, through which the slot 710 is machined, etched, cut, abraided or formed otherwise, bisecting the single conductive strip into two, electrically-isolated conductors. Another embodiment contemplates strips 720 and 722 that are on the upper surface but set back or away from the slot edges 718 and 719 although such a placement of the strips 720 and 722 is not shown in the figures.

Those of ordinary skill in the art should recognize that the slot 710 is formed by processes appropriate for the particular substrate material. The process or processes by which the slot is formed is not germane to the invention disclosed and claimed herein. In the preferred embodiment, the slots are not filled with a dielectric material; the slots are instead “filled” with air, which does however have a dielectric characteristic.

The conductive strips 720 and 722 that are separated by the slot 710 width “W” will have a distributed capacitance, “C” between them. Their capacitive coupling will be a function of spacing between the strips 720 and 722, the dielectric material, if any, filling the intervening space W, but also the surface area of each strip that faces its opposing strip, per unit length.

The conductive strips 720 and 722 will also have a distributed inductance, “L.” The inductance of the strips 720 and 722 will be a function of the strip thickness, the strip width, the intervening space W and the strip length. By virtue of the capacitance and inductance of the strips 720 and 722 and the dielectric between them, the strips 720 and 722 together act as a transmission line to high-frequency signals impressed across them. Inasmuch as the strips 720 and 722 act as a transmission line when they are separated by the slot 710, the combination of the slot and the strips are together referred to herein as a “slot transmission line.”

A second slot transmission line 730 (the conductors of which are also shown encircled as “L2”) is also formed in the upper surface 704 of the planar dielectric substrate 702, albeit laterally displaced from the first slot transmission line by a distance denoted as “S” in FIG. 29. As shown in FIG. 29, the slots of the first and second slot transmission lines are parallel to each other but separated from each other in a direction that is orthogonal to the slot's length-wise axes. The term “laterally displaced” should therefore be construed to mean the sideways displacement of one slot transmission line from the other. In FIG. 29, the lateral displacement between the two slot transmission lines 708 and 730 is “S.”

Like the first slot transmission line 708, the second slot transmission line 730 is formed by cutting or otherwise forming a slot 732 through the substrate 702. The second slot 732 depicted in FIG. 29, which corresponds to the second slot transmission line 730, also has two opposing surfaces or “faces” identified by reference numerals 734 and 736. The opposing surfaces 734 and 736 of the slot 730 are separated from each other by an intervening distance or width W. The second slot's 732 bottom, is identified by reference numeral 738.

It should be noted that the spacing W between the opposing surfaces 734 and 736 does not need to be the same as the spacing between the opposing surfaces 712 and 714 of the first slot transmission line. Similarly, the depth D of each slot does not need to be the same. The slots from which the slot transmission lines are formed can have different width and/or different depths. In addition, the conductive strips that abut the edges of each slot can be of different widths, thickness and/or length. In a preferred embodiment, the conductive strips each carry a differential signal.

Like the first slot, the second slot 732 has two upper “edges.” One edge 740 of the second slot 732 is formed by the intersection of the face 734 with the upper surface 704; the other edge 742 is formed by the intersection of the other, opposing face 736 with the upper surface 704. As with the first slot transmission line 708, after the second slot 732 is formed, the second slot transmission line 730 is formed by plating or otherwise applying two, electrically-isolated conductive strips 744 and 746 along each of the upper edges 740 and 742. Alternate and equivalent embodiments contemplate a second slot transmission line formed by a single conductive strip, through which the slot 732 is cut thereby bisecting the single conductive strip into the two, electrically-isolated conductors 744 and 746 shown in FIG. 29.

While the structure shown in FIG. 29 provides a structure having multiple slot transmission lines, FIG. 30 shows a transmission line structure 900 comprised of three multi-channel transmission line substrates 700 shown in FIG. 29 albeit with the addition of slots formed on the lower surfaces of the transmission line structures shown in FIG. 29.

In FIG. 30, the first or top, multi-channel transmission line substrate 700-1 is formed as set forth above in the description of the multi-channel transmission line 700 shown in FIG. 29. Slots 750 and 752 are formed in the upper surface 704-1 of the first substrate 702-1. Conductive strips 754 and 756 adjacent to the slot 750 form a “first slot transmission line” identified as “L₁.” The conductive strips 758 and 760 adjacent to slot 752 form a second slot transmission line identified as “L₂.” The first multi-channel transmission line structure 700-1, which is comprised of the two slot transmission lines L₁ and L₂, is also formed to have slots 762 and 764 in its lower or bottom surface 766. The slots 762 and 764 each have a depth that extends “up” into the substrate 702-1, but only part way into the thickness T of the planar dielectric substrate 702-1. These “lower” slots 762 and 764 in the top multi-channel transmission line structure 700-1 extend into the substrate 702-1 by a distance “d₁.” As shown, “d₁” is less than the difference between the thickness “T” and the depth “D” of the slots 750 and 752 formed in the upper surface of substrate 702-1 so that after the lower slots are formed, dielectric material separates the “bottom” of the upper slots 750 and 762 and the “bottom” of the lower slots 762 and 764. The depth “d,” of the lower slots 762 and 764 is deep enough to clear the surfaces of conductive strips 780, 782, 784 and 786 that are adjacent to slots 790 and 792 that are formed through the middle or second substrate 702-2 and from which a second or middle multi-channel transmission line 700-2 is formed.

Like the first multi-channel transmission line structure 700-1, the second multi-channel transmission line structure 700-2 has two, slot transmission lines formed from the conductive strips that abut the slots formed through the substrate 702-3. And, like the first multi-channel transmission line structure 700-1, the second such structure 700-2 is formed to have slots 794 and 796 in its lower or bottom surface 798. The slots 794 and 796 have a depth d₂ that also extends only part way into the thickness T of the planar dielectric substrate 702-2.

Finally, a third multi-channel transmission line structure 700-3, also has two, slot transmission lines formed from the conductive strips that abut the slots 802 and 804 formed through the substrate 702-3. Unlike the first and second multi-channel transmission line structures 700-1 and 700-2, the third such structure 700-3 does not have slots in its lower or bottom surface 806.

It can be seen in FIG. 30 that the slots in the lower surfaces of each layer are formed so that the lower-surface slots 762; 764; 794; 796 are below and opposite their corresponding upper-surface slots 750; 752; 790; 792 but also above slots formed in substrates beneath them. For example, the lower-surface slot 762 is below and opposite upper surface slot 750 but above the slot 790. The lower surface slot 794 is below and opposite the upper surface slot 790 but above the slot 802. Lower surface slot 762 is below and opposite upper surface slot 752 and above the slot 792, which is in the layer 700-2. The slots formed in the lower surface of each layer (i.e., the “lower surface slots”) are substantially parallel to the conductive surfaces (and slots in upper surfaces of layers beneath the lower surface slots) they cover.

When the bottom of each substrate layer is coated, plated or otherwise covered with an electrically conductive layer, such a conductive layer becomes an effective electromagnetic signal shield for the signals carried on the conductors over which the conductive layer exists. In FIG. 30, conductive material covering the lower surfaces of the different layers is identified by reference numeral 811. By covering the entire lower surfaces of the planar dielectric substrates, including the slots in the lower surfaces, with a conductive material 811 and coupling that material on each layer to a reference potential voltage, signals carried on the various slot transmission lines are effectively shielded from each other and from external electromagnetic interference. In a preferred embodiment, the conductive layers 811 on the lower surfaces of each layer are coupled to zero volts, which is also known as “ground” potential.

The conductive surfaces on the bottom or lower surface of each layer is coupled to the other such surfaces by way of conductive “vias” 808 that extend through each layer 700-1, 700-2 and 7003 and electrically contact the conductive surface on the bottom of each layer. For purposes of claim construction, a “via” is considered to be any passageway through a layer. An example of a “via” or passageway would include a hole or channel that extends completely through a layer. A “conductive via” should be considered to be any electrically-conductive pathway through a dielectric substrate by which a ground layer on one surface electrically communicates with another ground layer on another surface.

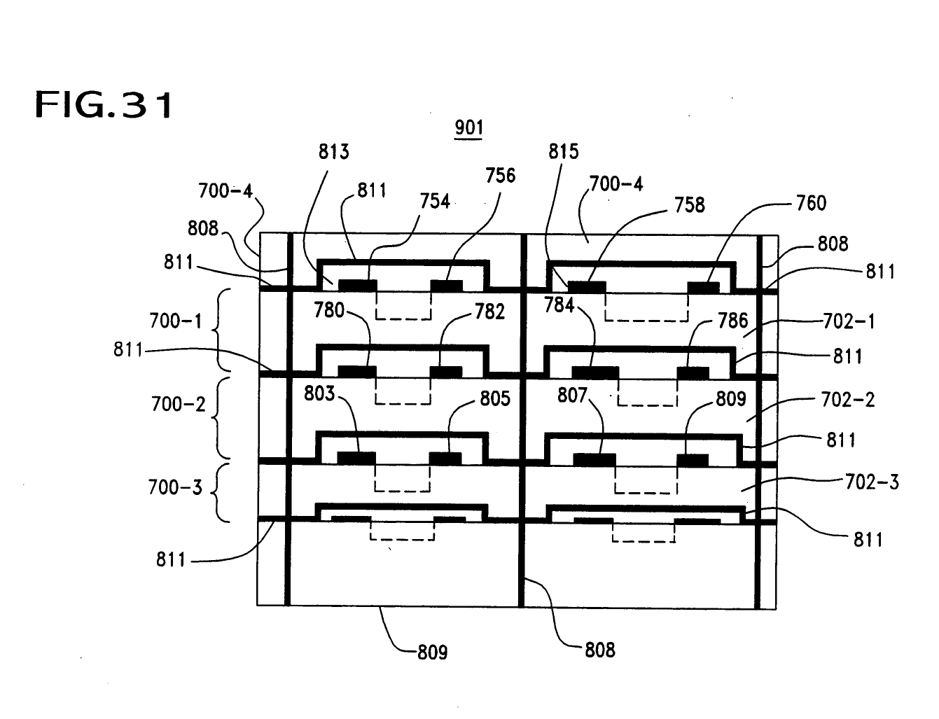

FIG. 31 shows an end view of a multi-layer transmission line structure 901, such as the one depicted in FIG. 30 albeit with a top cover layer 700-4, the bottom of which, has slots 813, 815 that cover conductive strips 754, 756, 758 and 760 that form conductors of transmission lines as described above. The bottom 809 of the structure 901 is also coated with conductive material 811 that is electrically coupled to the conductive material 811 on the bottom surfaces of the other layers by way of the aforementioned conductive vias 808.

Each of the conductive strips 754, 756, 758, 760, 780, 782, 784, 786, 803, 805, 807 and 809 extend into the plane in which FIG. 31 lies, whereat signal connections can be made to each of the conductive strips. Each of the ground layers 811 also extend into the plane of FIG. 31 so that connection can be made to the ground layers 811 as well.

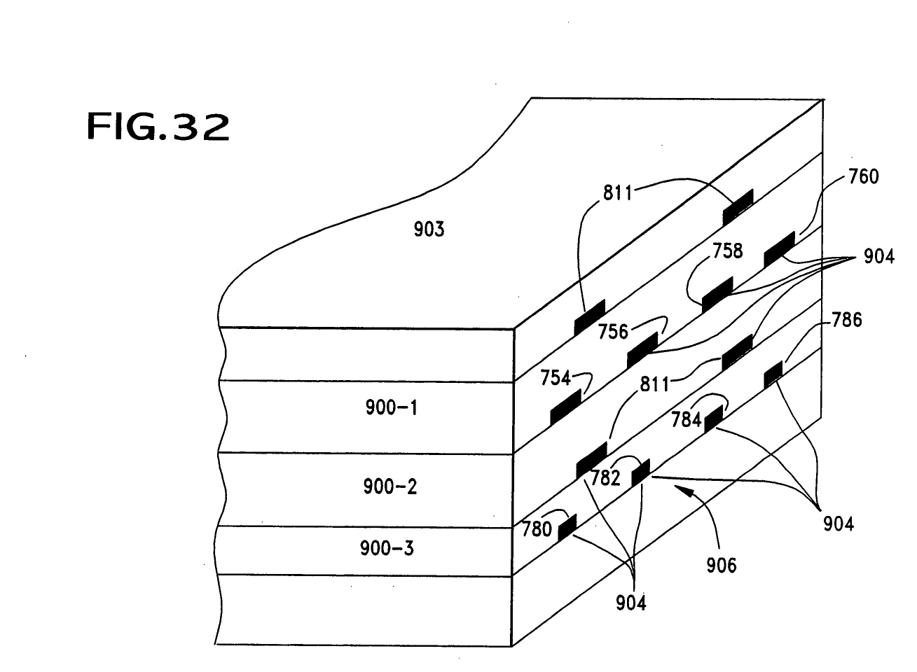

FIG. 32 is an isometric view of a multi-layer transmission line structure 903 having several waveguide modules 900-1, 900-2 and 900-3, stacked together, each of which conforms to the transmission line structures depicted in FIGS. 29 and 30. In FIG. 32 however, each waveguide module has its conductive layers extended to a common plane where electrical connections to the different conductive layers are embodied as terminals 904 on the planar termination end 906.

As shown in FIG. 32, one waveguide module identified by reference numeral 900-1 has upper and lower planar surfaces. A second waveguide module that is mechanically and electrically coupled to the first waveguide module is identified by reference numeral 900-2. A third waveguide module is identified by reference numeral 900-3. All three of these waveguide modules terminate in a common plane 906. Each of the waveguide modules have conductive strips as described above, electrical connections to which are embodied as the aforementioned terminals 904 and additionally marked by the reference numerals by which they are identified above.

By assembling several layers that each have slot transmission lines and extending the various conductive strips (and ground surfaces) to a common, planar end, the waveguide structure 900 depicted in FIG. 32 lends itself to use with a circuit board. The electrical terminals 904 on the planar end 906 can be conveniently coupled to signal terminals on a circuit board, the location and spacing of which match the terminals 905 on the waveguide structure. The slots associated with the waveguide structures in each layer may be disposed in alternating offset patterns to reduce coupling between vertically adjacent waveguides if intervening shields are not used.

While the preferred embodiment of the invention have been shown and described, it will be apparent to those skilled in the art that changes and modifications may be made therein without departing from the spirit of the invention, the scope of which is defined by the appended claims.

1. A multi-channel transmission line comprising:
a planar dielectric substrate having an upper surface and a lower surface and a thickness T;
a first slot transmission line formed in the upper surface of said planar dielectric substrate; and,
a second slot transmission line formed in the upper surface of said planar dielectric substrate, said second slot transmission line being laterally displaced from and substantially parallel to said first slot transmission line.

2. The multi-channel transmission line of claim 1, wherein the first slot transmission line and the second slot transmission line are each comprised of:
a slot formed through the upper surface of said planar dielectric substrate, said slot having first and second opposing faces spaced apart from each other by a first intervening space W, the intersection of said first opposing face with the upper surface defining a first slot edge, and the intersection of said second opposing face with the upper surface defining a second slot edge, said slot having a depth D;
a first conductive strip on the upper surface of the planar dielectric substrate and adjacent said first slot edge; and,
a second conductive strip on the upper surface of the planar dielectric substrate and adjacent said second slot edge.

3. The multi-channel transmission line of claim 2, wherein the slot comprising the first slot transmission line has a width W₁ and the slot comprising the second slot transmission line has a width W₂ that is different than W₁.

4. The multi-channel transmission line of claim 2, wherein the first conductive strips and the second conductive strips are capable of carrying differential signals.

5. The multi-channel transmission line of claim 2, further including a slot in the lower surface of said planar dielectric substrate, said slot in the lower surface having a depth that is less than T-D, and being located opposite at least one of the slots formed through the upper surface for each of the first and second slot transmission lines.

6. The multi-channel transmission line of claim 2, further including a first slot in the lower surface of said planar dielectric substrate, said first slot in the lower surface having a depth less than T-D, and being located opposite the slot comprising the first slot transmission line; and,
a second slot in the lower surface of said dielectric substrate, said second slot in the lower surface being parallel to the first slot in the lower surface and also having a depth less than T-D, and being located opposite located opposite the slot comprising the second slot transmission line.

7. The multi-channel transmission line of claim 6, further including an electrically conductive layer substantially covering the lower surface of the planar dielectric substrate and substantially covering the first and second slots in the lower surface.

8. The multi-channel transmission line of claim 7, wherein said electrically conductive layer is electrically coupled to a reference potential for differential signals on said first and second slot transmission lines.

9. The multi-channel transmission line of claim 8, wherein said reference potential is zero volts.

10. A transmission line structure comprised of:
a first multi-channel transmission line including a planar dielectric substrate having an upper surface and a lower surface and a thickness T;
a first slot transmission line, said first slot transmission line being formed from a slot through the upper surface of said planar dielectric substrate and having a width W₁ and depth D₁;
a second slot transmission line, said second slot transmission line being formed from a slot through said planar dielectric substrate and having a width W₂ and a depth D₂;
a first slot in the lower surface of said dielectric substrate, said first slot in the lower surface having a depth less than T-D₁, and being located below the first slot transmission line; and,
a second slot in the lower surface of said dielectric substrate, said second slot in the lower surface being parallel to the first slot in the lower surface and also having a depth less than T-D₂, and being located below located opposite the second slot transmission line;
an electrically conductive layer substantially covering the lower surface of the planar dielectric substrate and substantially covering the first and second slots in the lower surface; and,
a second multi-channel transmission line having a planar dielectric substrate, the upper surface of which is coupled to the lower surface of said first multi-channel transmission line.

11. The transmission line structure of claim 10, wherein said first slot transmission line and second slot transmission line each include a slot formed through the upper surface of said planar dielectric substrate, said slot having first and second opposing faces spaced apart from each other by a first intervening space, the intersection of said first opposing face with the upper surface defining a first slot edge, and the intersection of said second opposing face with the upper surface defining a second slot edge, said slot having a depth D;
a first differential signal strip on the upper surface and adjacent said first slot edge; and,
a second differential strip on the upper surface adjacent the second slot edge.

12. The transmission line structure of claim 11, wherein the planar dielectric substrate of the first multi-channel transmission line and the planar dielectric substrate of the second multi channel transmission line each include an end that is orthogonal to the upper and lower surfaces.

13. The transmission line structure of claim 12, wherein said first and second differential signal strips of said first and second slot transmission lines and the electrically conductive layer of said first multi-channel transmission line and said first and second differential signal strips of said first and second slot transmission lines and the electrically conductive layer of said second multi-channel transmission line, are each electrically coupled to a corresponding terminal on the ends of the first and second multi-channel transmission lines.

14. A stacked transmission line structure comprised of:
a first waveguide module having upper and lower planar surfaces and a first planar termination end, said first waveguide module comprised of first and second slot transmission lines formed in the upper planar surface of the first waveguide module, said first and second slot transmission lines having differential signal conductors that terminate in said first planar termination end; and,
a second waveguide module having upper and lower planar surfaces and a second planar termination end, said second waveguide module comprised of first and second slot transmission lines formed in the upper planar surface of the second waveguide module and being coupled to said first waveguide module, said first and second slot transmission lines of the second waveguide module having differential signal conductors that terminate in said second planar termination end, said first and second planar termination ends being co-planar.
